(19) United States
(12) Patent Application Publication
(10) Pub. No.: US 2005/0219565 A1
(43) Pub. Date: Oct. 6, 2005

(54) Image processing device and image processing program allowing computer to execute image processing

(75) Inventor: Tetsuya Suzuki, Nagano-ken (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/897,388

(22) Filed: Jul. 22, 2004

(30) Foreign Application Priority Data
Jul. 23, 2003 (JP) 2003-200378

(51) Int. Cl. G06K 1/00

(52) U.S. Cl. 358/1.9

(57) ABSTRACT

An image processing program causes a computer to execute an image processing procedure to generate image data for each pixel based on a rendering command. The image processing procedure includes: a procedure that expands image data for each pixel of a predetermined color space, based on the rendering command; and a compression procedure that compresses the image data for each pixel by considering repetition of the image data. The expansion procedure includes a resolution conversion procedure that replaces, with respect to an adjacent pixel group having of a plurality of adjacent pixels, the image data for each pixel in the adjacent pixel group with the image data of any pixel in the adjacent pixel group, in cases where a differential of luminance-related values of the image data between the plurality of adjacent pixels is equal to or less than a predetermined threshold value.

### BACKGROUND OF THE INVENTION

1. Field of the Invention

The present invention relates to an image processing device and an image processing program that causes a computer to execute image processing, and, more particularly, to an image processing device and an image processing program capable of increasing the compression ratio by raising the repetition of pixel image data by means of resolution conversion.

2. Description of the Related Art

A printer that prints images created by a host computer is confronted by a variety of strict demands such as low costs, high-speed printing, and high quality printing. More particularly, host-based printers, for which the majority of image processing for printing is performed by the printer driver of the host computer, have been proposed due to cost-reduction demands.

In these host-based printers, image data, which is expanded into RGB values or CMYK values corresponding with the printer toner for each pixel, is generated by a printer driver from a rendering record generated by an application on the host computer, whereupon the generated image data is compressed and transferred to the printer. The printer extends the received image data, performs binarization such as screen processing, and then produces an image on the print medium by means of a printer engine. Because the majority of the image processing is executed by an image processing program on the host computer in line with the increase in host computer performance, the image processing device in the printer controller can be greatly reduced, which can be associated with printer cost reductions.

The above described host-based printer is disclosed in Japanese Patents No. 3284464, No. 3367555, and No. 3367556.

### SUMMARY OF THE INVENTION

In comparison with a conventional printer, which receives print data in page description language before performing image processing and printing, in the case of the host-based printer, image data expanded into pixels on the host computer side must be compressed before being transferred to the printer. When the volume of this image data increases, the time taken for the image data to be transferred from the host computer to the printer becomes longer, and there are therefore problems such as a drop in the printing throughput. More particularly, according to a compression algorithm that takes into consideration repetition of previous raster image data and previous pixel image data, a compression ratio of parts of the image becomes poorer in the case of page resources including image, there being a tendency for the size of the transferred image data to increase.

Therefore, an object of the present invention is to provide an image processing device and an image processing program capable of improving the compression ratio of image data expanded into pixels.

In order to resolve the above object, one aspect of the present invention is an image processing program that causes a computer to execute an image processing procedure to generate image data for each pixel based on a rendering command, wherein the image processing procedure comprises: a procedure that expands image data for each pixel of a predetermined color space, based on the rendering command; and a compression procedure that compresses the image data for each pixel by considering repetition of the image data, and wherein the expansion procedure includes a resolution conversion procedure that replaces, with respect to an adjacent pixel group having of a plurality of adjacent pixels, the image data for each pixel in the adjacent pixel group with the image data of any pixel in the adjacent pixel group, in cases where a differential of luminance-related values of the image data between the plurality of adjacent pixels is equal to or less than a predetermined threshold value.

According to the above aspect of the invention, resolution conversion can be performed by replacing adjacent pixels having close luminance-related values that are inconspicuous to the human eye with common image data, whereby the compression ratio of the compression procedure can be improved. Accordingly, the time taken to transfer image data from the host computer to the printer can be reduced and the printing throughput can be raised.

Furthermore, in order to achieve the above object, another aspect of the present invention is an image processing program that cause a computer to execute an image processing procedure to generate image data for each pixel based on a rendering command and transfer the image data to, a printing device, wherein the image processing procedure comprises: a procedure that expands image data for each pixel of a predetermined color space, based on the rendering command; a color conversion procedure that converts the image data of the predetermined color space for each pixel generated by the expansion procedure into image data for the color space of color material of the printing device; and a compression procedure that compresses the color converted image data for each pixel by considering repetition of the image data, the expansion procedure includes a resolution conversion procedure, which, with respect to an adjacent pixel group having a plurality of adjacent pixels, replaces the image data for each pixel in the adjacent pixel group with common image data in cases where a differential of luminance-related values of the image data between the plurality of adjacent pixels is equal to or less than a predetermined threshold value; and in the color conversion procedure, after a predetermined pixel image data is color-converted, pixel that has the same image data as the predetermined pixel image data is provided with the color-converted image data.

According to the above other aspect, because, in the color conversion procedure, color conversion procedure is not repeated for the same image data, the processing time of the color conversion process can be reduced and the printing throughput can be improved.

### BRIEF DESCRIPTION OF THE DRAWINGS

FIG. 1 shows the configuration of a host computer and printer according to the present embodiment;

FIG. 2 is a flowchart showing the processing procedure of an image processing program that is the printer driver of the present embodiment;

FIG. 3 shows an example of an image that is printed by means of a rendering record;

FIG. 4 shows an example of a rendering record and of intermediate code;

FIG. 5 shows a flowchart representing resolution conversion processing and the corresponding image data;

FIG. 6 shows a flowchart for two-stage resolution conversion processing and the corresponding image data;

FIG. 7 is a detailed flowchart for color conversion processing S20;

FIG. 8 shows the configuration of the host computer and printer according to another embodiment; and

FIG. 9 is a flowchart showing the image processing procedure of a printer driver 14 according to the present embodiment.

### DESCRIPTION OF THE PREFERRED EMBODIMENTS

Embodiments of the present invention will be described below with reference to the drawings. However, the scope of protection of the present invention is not limited to the following embodiments, but rather extends to the inventions that appear in the claims as well as to any equivalents thereof.

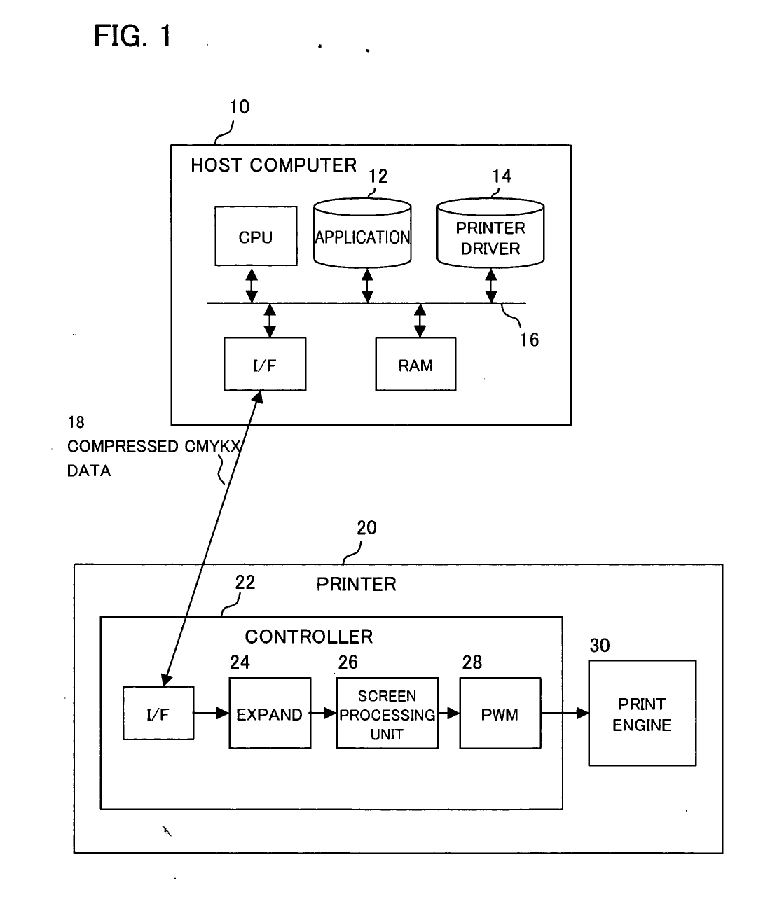

FIG. 1 shows the configuration of the host computer and printer according to the present embodiment. The host computer 10 comprises a CPU, RAM, and interface means I/F that are connected via an internal bus 16. Furthermore, an application program 12 such as a rendering program or a word processor for generating a rendering record, and a printer driver program 14 for generating compressed CMYK data 18 corresponding to the color material of the printer by image-processing a rendering record generated by the application program 12, are installed on a recording medium such as a HDD.

The printer 20 receives compressed CMYK data 18 from the interface I/F of the host computer 10 via a predetermined communication medium. The communication medium may be a wired communication medium such as a USB cable or a wireless communication medium such as an IEEE802.11 wireless LAN or other wireless LAN. Upon receipt of the compressed CMYK image data 18, the controller 22 of the printer 20 expands the compressed data by means of an expansion circuit 24, performs binarization for each CMYK color plane of each pixel by means of a screen processing unit 26, pulse-width modulates the binary data by means of a pulse width modulation circuit 28, and then supplies a drive pulse signal to a print engine 30. For example, the print engine 30 forms a latent image on a photosensitive drum by means of laser beam driven by a drive pulse signal, develops the image by means of CMYK developing toner, and then transfers the developed image to the print medium. In cases where the print engine 30 prints the image on a print medium by means of ink jets, an error diffusion processing unit and an inkjet-nozzle drive signal generation section are provided in place of the screen processing unit 26 and PWM 28, and so forth.

The printer driver 14 installed in the host computer 10 generates compressed CMYK data 18 corresponding with the color material of the printer by image-processing the rendering record generated by the application program 12. Further, in order to raise the compression ratio of the compressed CMYK data, processing to increase the repetition of the image data for each pixel is performed by carrying out resolution conversion in accordance with luminance-related values such as luminance values, brightness, and so forth, as will be described subsequently.

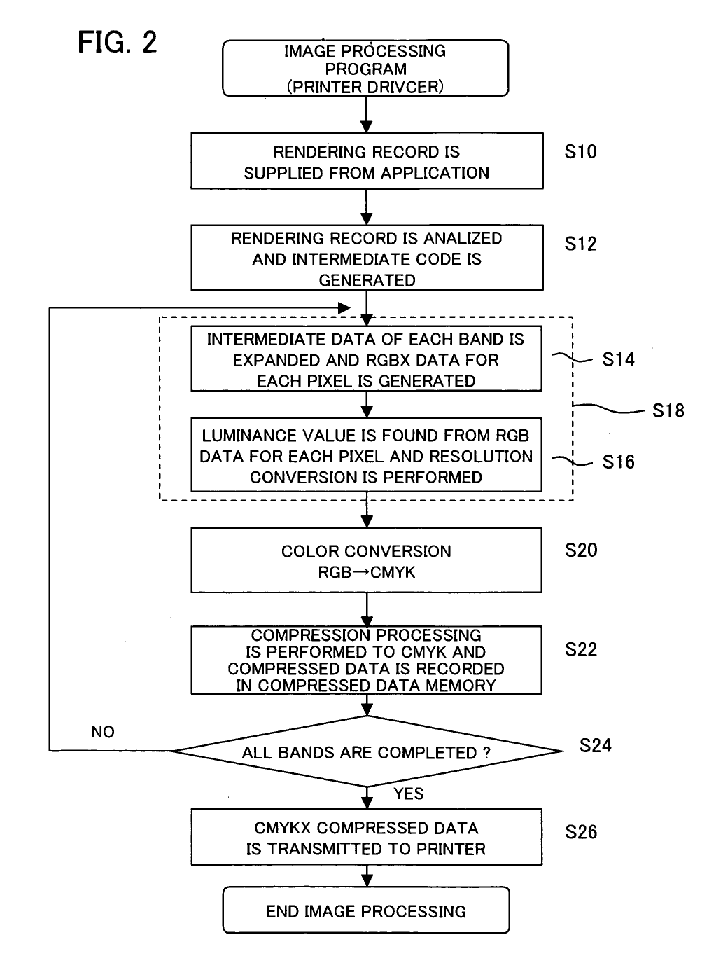

FIG. 2 is a flowchart showing the processing procedure of an image processing program that is the printer driver of this embodiment. A GDI (Graphical Device Interface)-format rendering record generated by the application program 12 is supplied to the printer driver 14 (S10).

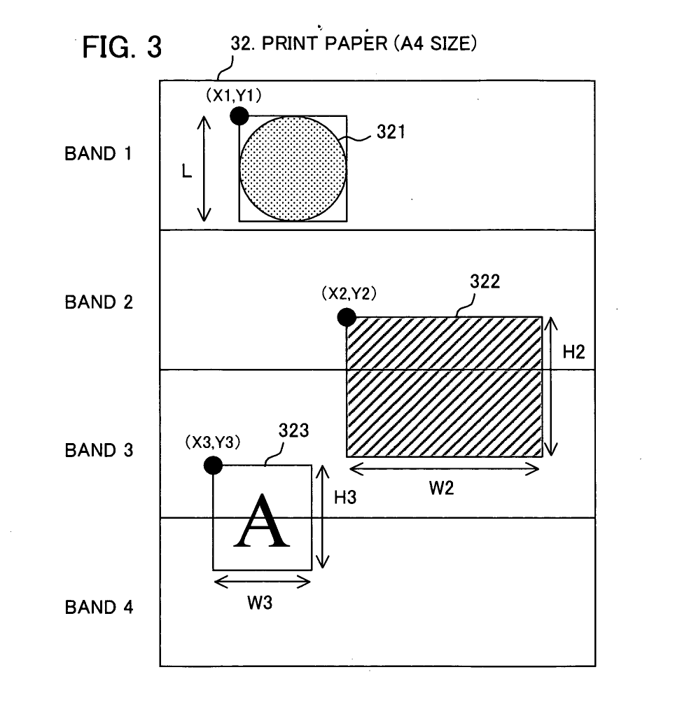

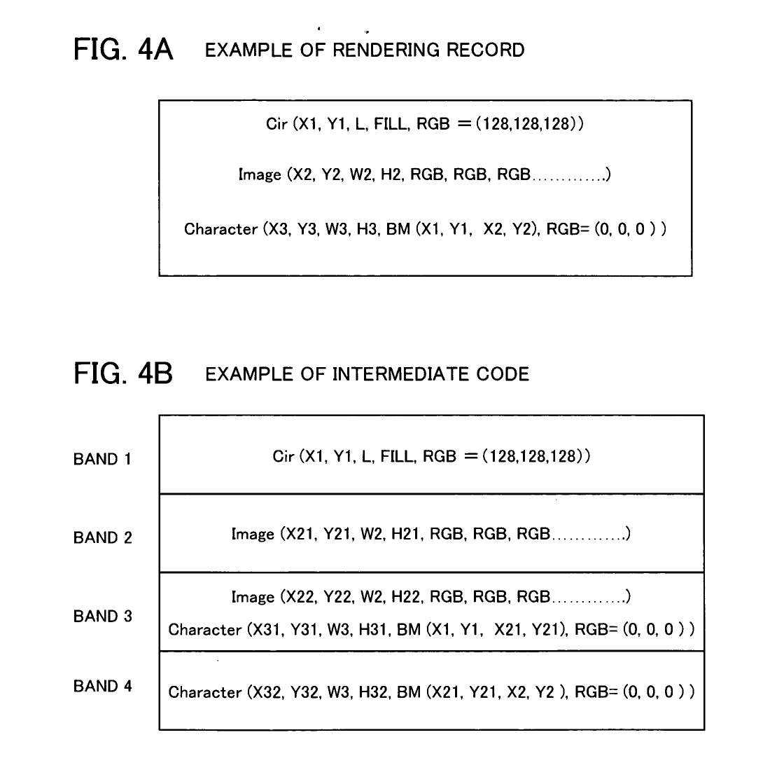

Here, FIG. 3 shows an example of page-resource image that is printed by means of the rendering record. The image example is an example in which an image consisting of a circle 321 constituting an example of a graphic, an image 322 such as a photographic image, and a character 323 are printed on A4-size print paper (print medium) 32. An example of the rendering record, which is the principal component of this image, is shown in FIG. 4A. That is, a rendering record (Cir), which fills the inside of a circle of diameter L in a position with co-ordinates (X1, Y1) with color RGB=(128, 128, 128) is supplied for circle 321. Here, RGB data are values representing the grayscale values of the 256 grayscales of each color. In addition, a rendering record (image) that has image data representing the color RGB of each pixel in an area of width W2 and height H2 from a position with the coordinates (X2, Y2), is supplied for the image 322. That is, where the image 322 is concerned, the data has already been expanded into pixel image data. Further, a rendering record (character), which represents the rendering, by means of the color RGB=(0, 0, 0) (black), of data with addresses (X1, Y1) to (X2, Y2) of a bitmap data file BM (not shown) in which character ‘A’ bitmap data is stored, in an area of width W3 and height H3 in a position with the coordinates (X3, Y3), is supplied for character 323.

Returning now to FIG. 2, when a rendering record as per FIG. 4A is supplied, the printer driver 14 analyzes the rendering record, and generates (S12) intermediate code comprising a function for image expansion, and so forth, for each of a plurality of bands divided into a predetermined number of rows of the print medium. This intermediate code is one type of rendering command. FIG. 4B shows an example of intermediate code. For the sake of convenience, the code of the intermediate code here is the same as the code of the rendering record. As shown in FIG. 3, here, the area of the A4-sized print medium is divided into four bands.

The intermediate code in FIG. 4B contains code (rendering code) that completely expands the circle 321, which is one graphic, in band 1. That is, this code is intermediate code that expands a filled circle of diameter L in a position with the coordinates (X1, Y1) by means of color data RGB=(128, 128, 128). Further, the intermediate code contains code (a rendering command) that renders a portion of the image 322 in band 2. That is, this is intermediate code that expands an image with color data RGB for each pixel in an area of width W2 and height H21 from a position with the coordinates (X21, Y21) in band 2. Furthermore, the intermediate code contains code (a rendering command) that renders the remaining portion of image 322 and a portion of character 323 in band 3. That is, this code includes intermediate code that expands an image with color data RGB for each pixel in an area of width W2 and height H22 from a position with the coordinates (X22, Y22) in band 3, and intermediate code that expands, by means of colors RGB=(0, 0, 0), bitmap data BM within an area of width W3, height H31 from a position with the coordinates (X31, Y31) in band 3. Further, the intermediate code includes intermediate code that renders the remaining portions of the character 323 in band 4.

The intermediate code includes function code (or a rendering command) for expansion that is uniquely assigned to the printer driver 14 corresponding with the printer 20, and, even when the rendering code of an application is different, the rendering code is converted into the common intermediate code so that the common expansion procedure of the printer driver 14 can expand the intermediate code into image data for each pixel.

Next, the printer driver 14 performs expansion from the intermediate code into image data RGBX for each pixel in each band (S14). The image data RGBX consists of pixel color data R(red), G(green), and B(blue), and attribute data X indicating the image type, each of these image data RGBX being constituted by 8-bit data. The image types are, for example, graphics such as circles and graphs, characters, and images such as photographs and natural images, these image types being classified by attribute data X, and are utilized in the allocation of the optimal process in the screen processing of the printer controller and so forth.

Expansion Processing

By expanding the above-mentioned intermediate code, the expanded image data RGBX for each pixel is stored in the band memory region in the RAM in the host computer 10. In an initialization state, white data with RGB=(255, 255, 255) is written to the band memory as color data RGB, for example, and graphics data is written as the image-type data for the attribute data X. Further, in band 1, pixel image data for the area in the circle 321 is generated by means of the intermediate code that expands circle 321, and written to the band memory. In band 2, pixel image data in the upper part of the image 322 is written to the band memory. In addition, in band 3, pixel image data for the remaining lower portion of image 322 is written to the band memory and pixel image data for the upper part of the character 323 is written to the band memory. Further, in band 4, pixel image data for the remaining lower part of character 323 is written to the band memory.

Resolution Conversion Processing

Next, the printer driver 14 finds the luminance values from the RGB data for each pixel of the image data, and then performs resolution conversion processing (S16). More specifically, the printer driver 14 finds the luminance values of each pixel from RGB data for adjacent pixel groups of a plurality of adjacent pixels and it is then judges whether the differential of the luminance values between adjacent pixels is equal to or less than a threshold value. If this differential is equal to or less than the threshold value, image data RGB of a plurality of pixels of the adjacent pixel groups are replaced by the image data of any pixel. Accordingly, image data in adjacent pixel groups comprising pixels whose luminance values are close then become common image data whose resolution is zero, whereby the resolution is lowered by the conversion.

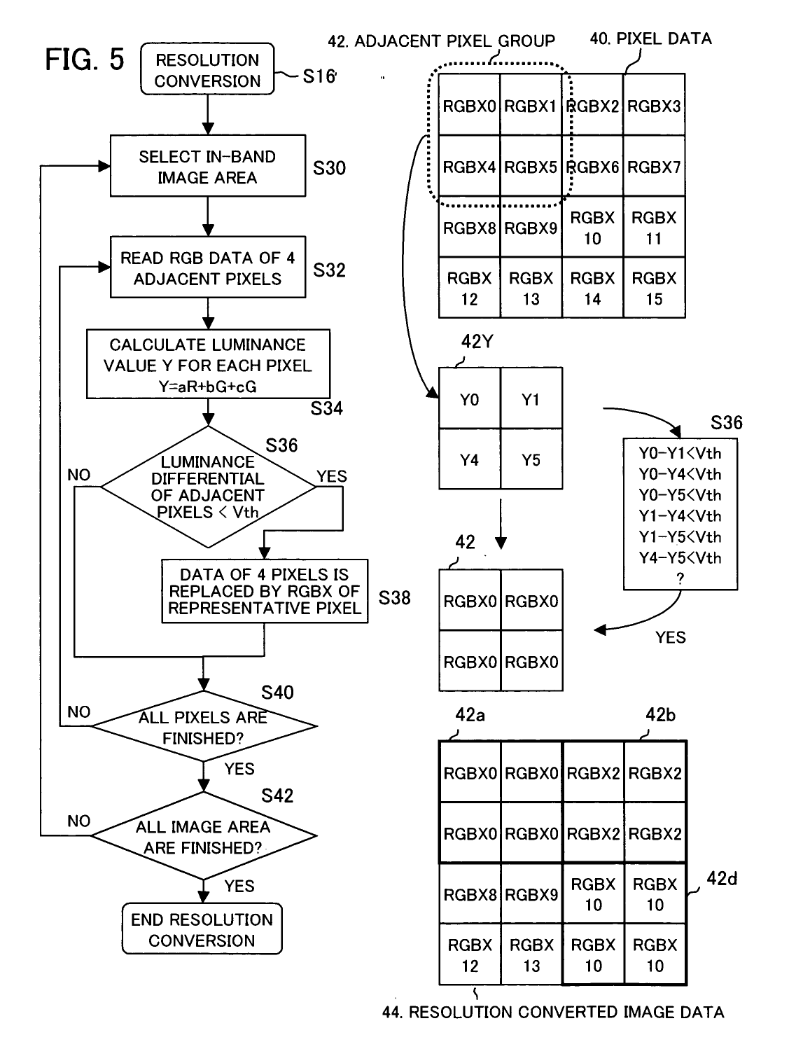

FIG. 5 shows a flowchart showing resolution conversion processing and the corresponding image data. Resolution conversion processing S16 is performed on the in-band image area but is not performed for graphics, characters, and so forth. Therefore, an in-band image area is selected (S30). The image data 40 of the image area is shown in FIG. 5. Here, as an example of the image data 40, a 16-pixel image area of 4 rows and 4 columns is shown. The resolution conversion processing S16 of the printer driver 14 reads the RGB data of four adjacent pixels in two adjacent rows and two adjacent columns from the band memory in the RAM (S32). The plurality of adjacent pixels in two rows and two columns is called as an adjacent pixel group 42. The number of pixels in the adjacent pixel group 42 may be 9 adjacent pixels in 3 rows and 3 columns, but is most preferably four adjacent pixels of 2 rows and 2 columns. The resolution conversion is processing that involves replacing the data with the pixel image data (RGB data) of any one pixel when the values for the luminance of the pixels in the adjacent pixel groups are close. This processing lowers the resolution of the image, and, therefore, the drop in resolution is kept to 1/2 by using the smallest conversion units, which are two rows and two columns, whereby an excessive drop in resolution can be avoided.

Next, the resolution conversion processing S16 calculates the luminance value Y of each pixel from the image data RGB0, RGB1, RGB4, and RGB5 of each pixel in the adjacent pixel group 42 (S34). The arithmetic equation for finding the luminance value Y is as follows:
Y=aR+bG+cB=0.2990*R+0.5870*G+0.1140*B

The arithmetic equation is a floating-point operation and, hence, in order to increase the computation speed, the following arithmetic equation, which is the result of changing coefficients rendered by multiplying each of the coefficients a, b, and c by 65536, is preferable. All of the luminance values Y are integer values in this arithmetic equation, where by the computation speed can be raised.
Y=19595*R+38470*G+7471*B

A judgment of whether the luminance differential between adjacent pixels is equal to or less than a predetermined threshold value Vth is made with respect to the luminance value 42Y of four pixels in the adjacent pixel group 42 (S36). That is, it is checked whether the luminance-value differences of these pixels are equal to or less than the threshold value Vth for a combination of six types of adjacent pixels. The threshold value Vth is set at about 64 (25%) or 128 (50%) grayscales in the case of at most 256 grayscales. The threshold value Vth can be suitably selected by considering the drop in image quality. In addition, the combination of adjacent pixels is not necessarily limited to six types. There may also be only four types that are left, right, top, and bottom.

Further, when the six types of differential of the luminance value Y are all equal to or less than the threshold value Vth, the pixel image data of the adjacent pixel groups 42 is replaced by the image data of any pixel in the adjacent pixel groups (S38). In the example in FIG. 5, replacement with the image data RGBX0 of the top-left pixels is performed, such that the pixel image data in the adjacent pixel groups 42a all become RGBX0 and common image data. The resolution of the adjacent pixel groups 42 does not change as a result. Further, in cases where any of the six types of differential of the luminance values Y exceeds the threshold value Vth, the image data of the pixels in the adjacent pixel groups 42 are not changed.

The resolution conversion processing with respect to the adjacent pixel groups 42 is then repeated for all the pixels in the selected image area (S40). That is, adjacent pixel groups 42 consisting of 2×2 pixels in the image area are sequentially readout, resolution conversion processing is performed on these groups 42, and, when the luminance values are close, image data are replaced by representative pixel image data. In addition, processing is repeated for all the image areas in the same band (S42). FIG. 5 shows an example of image data 44 that has undergone resolution conversion. In, this example, in three adjacent pixel groups 42a, 42b, and 42d, each of which is shown with a thick frame, the luminance value differential between adjacent pixels is small, and the pixels in the adjacent pixel groups are rewritten as the representative pixel image data RGBX0, RGBX2, and RGBX10. In another adjacent pixel group, the luminance value differential between pixels exceeds the threshold value, and hence rewriting to representative pixel image data is not performed, which gives the original image data RGBX8, RGBX9, RGBX12, and RGBX13.

The grounds for performing resolution conversion are that, because the human eye is highly sensitive to variations in image brightness, when the variation in the luminance values of adjacent pixels is small, even though the image data of these adjacent pixels are changed into the same, the image quality is not dropped excessively. Therefore, the repetition of the image data can be improved by replacing image data with representative pixel-image data in such image groups, whereby the efficiency of subsequent color conversion processing is improved and the compression ratio can be raised.

In cases where the resolution of the print engine 30 of the printer is a relatively low resolution such as 300 dpi, the resolution can be lowered to 150 dpi at most by performing a single resolution conversion process on a 2×2 pixel adjacent pixel group. However, when the resolution of the print engine 30 is a relatively high resolution such as 600 dpi, the resolution conversion processing is performed on adjacent pixel groups of 2×2 pixels, and, in cases where the resolution conversion is performed on all the 2×2 pixel adjacent pixel groups in a 4×4 pixel adjacent pixel group, the same resolution conversion processing is preferably performed to the four adjacent pixel groups which are viewed as new adjacent pixel groups. By performing resolution conversion processing twice, a 600-dpi resolution is reduced to 150 dpi at most.

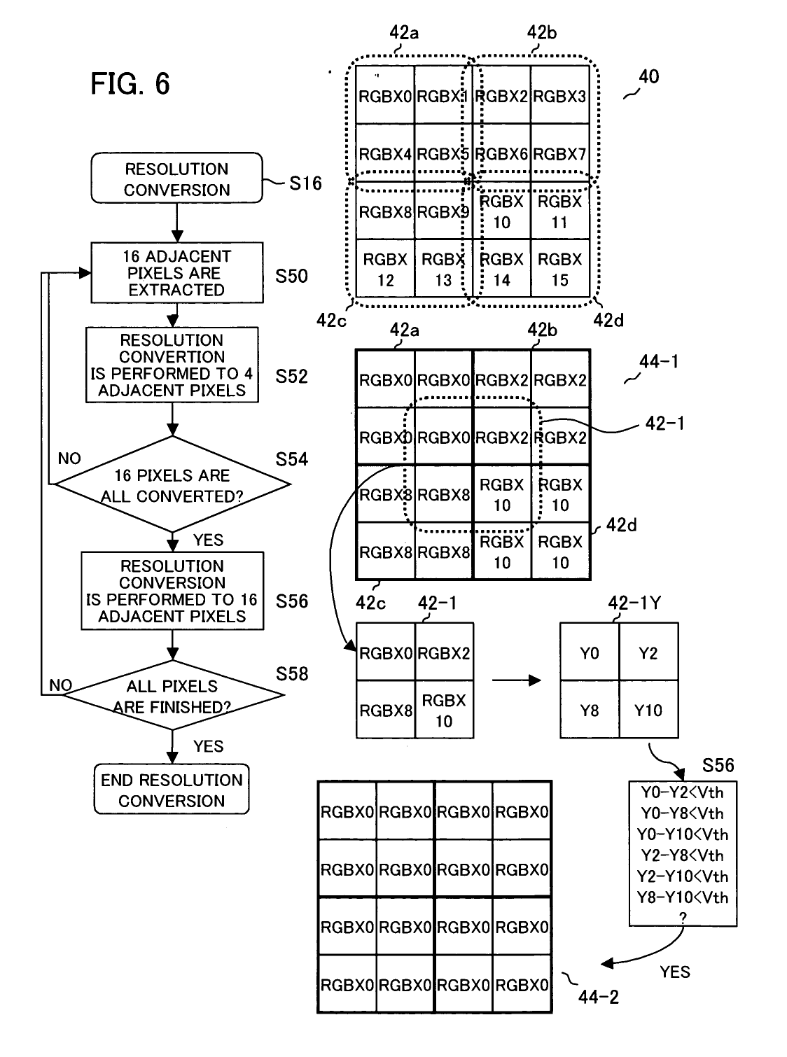

FIG. 6 shows a flowchart for two-stage resolution conversion processing and the corresponding image data. In order to carry out two-stage resolution conversion processing, 16 adjacent pixels (4×4 pixels) in an image area are extracted (S50). Next, resolution conversion processing is sequentially performed (S50) on adjacent 2×2-pixel adjacent pixel groups 42a, 42b, 42c, and 42d among the 16 pixels. The resolution conversion processing with respect to the 2×2-pixel adjacent pixel groups is the same as the processing shown in FIG. 5. FIG. 6 shows image data 44-1 on which first-stage resolution conversion processing has been performed. In this example, resolution conversion is performed on all four adjacent pixel groups 42a, 42b, 42c, and 42d, and the 4-pixel image data in these four adjacent pixel groups is replaced by RGBX0, RGBX2, RGBX8, and RGBX10 respectively.

In cases where resolution conversion is performed in all 4 adjacent pixel groups among the 16 pixels (YES in S54), second-stage resolution conversion is also performed to the four adjacent pixel groups which are viewed as four adjacent pixels 42-1 (S56) . As shown in FIG. 6, the respective luminance values Y0, Y2, Y8, and Y10 are determined (42-1Y) from the image data RGBO, RGB2, RGB8, and RGB10 of each pixel of the four adjacent pixels 42-1, then judging whether the six types of differential with these luminance values are equal to or less than the threshold value Vth (S56). In cases where all differentials are equal to or less than the threshold value, the image data of all 16 pixels is replaced by representative pixel image data RGBX0. In cases where, in this judgment, any one of the differentials of the luminance values are not equal to or less than the threshold value, replacement of the 16-pixel image data is not carried out, the image data being unchanged from the image data 44-1 after the first-stage resolution conversion processing. Further, in cases where resolution conversion has not been performed in any of the 4 adjacent pixel groups among the 16 pixels (NO in S54), second-stage resolution conversion is not performed.

FIG. 6 shows image data 44-2 after second-stage resolution conversion is performed. As shown here, 4×4 pixel image data are all replaced by RGBX0, and the resolution among the 16 pixels then becomes zero.

As described above, the resolution conversion of this embodiment does not change or reduce the number of pixels, and but increases repetition in the image data by replacing adjacent pixel image data with the same image data.

Returning now to FIG. 2, in the above example, the printer driver 14 expands the in-band intermediate code to generate RGBX image data for each pixel, writes the RGBX data to band memory (S14), and then sequentially performs resolution conversion processing S16 on adjacent pixel groups. However, the above expansion processing S14 and resolution conversion processing S16 may be performed at the same time. That is, when expansion from the intermediate code to the image data for each pixel is performed, the pixels of the adjacent pixel groups are expanded, the luminance values are calculated from the expanded pixel image data, and, in cases where the luminance values of the adjacent pixels are close, representative pixel image data are provided for the pixels in the adjacent pixel groups and written to the band memory. When two-stage resolution conversion is performed, the above processing is sequentially performed on sixteen (4×4) pixels.

Color Conversion Processing

Returning now to FIG. 2, RGB image data that has been expanded pixel by pixel and then subjected to resolution conversion is converted (S20) to CMYK image data corresponding with the color space of the toner used by the print engine 30 of the printer. The color conversion is executed by a tetrahedral interpolation calculation referring to a color conversion table created in advance. However, since the repetition where the same image data RGBX is provided in adjacent pixels becomes high according to the previous resolution conversion, when the image data is the same, the converted CMYK image data is employed without repeating the tetrahedral interpolation calculation of the color conversion.

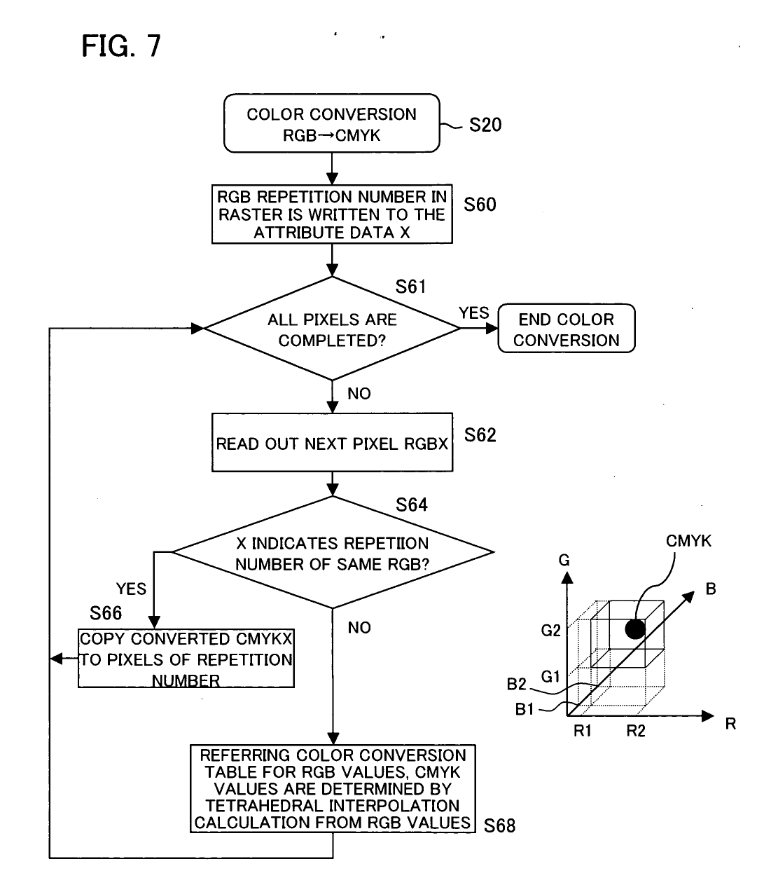

FIG. 7 is a detailed flowchart for color conversion processing S20. First, for the image data in the band memory, pixels whose image data RGB are repeated in the same raster are searched and the repetition number is added to the attribute data X of the second pixel (S60). This process is performed on all the rasters in band memory. Further, until the color conversion processing of all the pixels in band memory has been completed (S61), pixel RGBX image data is read out (S62), and the required color conversion processing is performed. Initially, when the image data RGBX are repeated, the repetition number is added to attribute data X of the second pixel. Therefore, in the color conversion processing, a check of whether the attribute data X of the read pixel image data RGBX indicates the number of repetitions of the same RGB values is made (S64). If the repetition number is not indicated (NO in S64), the color conversion table is referenced with respect to the read RGB values, whereby the CMYK values are determined by means of a tetrahedral interpolation calculation (S68). Further, when the attribute data X indicates the repetition number (YES in S64), the already converted CMYKX values are copied as color conversion data to the pixels corresponding with the repetition number (S66). Repetition of the color conversion calculation processing can thus be avoided.

FIG. 7 shows the principles behind the tetrahedral interpolation calculation of the color conversion processing. The color conversion table already recorded on a recording medium of the host computer contains respective CMYK grayscale data for combinations of gray scale data in 3 RGB color planes. However, if, for three RGB color planes with 256 grayscales, CMYK data corresponding with all 256 grayscale combinations is held, the data amount of the color conversion table is the cube of 256 and the data volume is huge. Therefore, the color conversion table contains CMYK data for lattice points of grayscale values which are thinned out at a predetermined rate with respect to three RGB color planes. Accordingly, in cases where image data RGB targeted for color conversion lies between grayscale values R1 and R2 of respective lattice points prepared for the color conversion table, and between the grayscale values G1 and G2 and between the grayscale values B1 and B2 thereof respectively, the image data CMYK corresponding with the image data RGB to be color-converted is then determined by means of a tetrahedral interpolation calculation. Therefore, color conversion processing in accordance with this tetrahedral interpolation calculation is heavy processing that takes a relatively long time. More particularly, when the calculation is performed by means of a computer program such as a printer driver, the processing time tends to be longer.

In this embodiment, the resolution conversion processing is performed so that the same image data is given to areas in which the variation in luminance values is small. Therefore, already converted image data CMYK is given to pixels with the same image data as the color converted pixel in the same raster direction, and color conversion computation is not repeated for these pixels. Accordingly, the time required for color conversion processing can be markedly reduced.

As shown in FIG. 7, when color conversion processing has been completed for all the pixels in band memory, pixel image data in band memory are all converted to CMYKX image data. The attribute data X is the same as the attribute data X of the RGBX image data.

Compression Processing

Returning now to FIG. 2, compression processing is performed on the CMYKX image data written to the band memory, with respect to each of 5 color planes, and the compressed data is then written to a compressed data memory in the RAM (S22). The compression method is performed by taking the repetition of in-band pixel image data into consideration. For example, when the image data is the same as the pixel image data in the right preceding raster or the same as the right preceding pixel image data, the image data is then converted only to data representing repetition instead of CMYKX data (8 bits each, giving a total of 8×5=40 bits) or is converted to data indicating the repetition number. By thus adopting a compression method that performs compression with an emphasis on repetition, the compression ratio of image data in which repetition has increased due to the resolution conversion of this embodiment can be increased further.

The expansion into in-band pixel image data and resolution conversion processing S18, color conversion processing S20, and compression processing S22 are performed for each band. When the processing for all the bands is complete (YES in S24), one page's worth of compressed CMYKX data 18 (see FIG. 1) is transferred to the controller 22 of the printer 20 (S26). On the printer side, as shown in FIG. 1, the controller 22 transfers laser drive pulse data to the print engine 30 by subjecting the received compressed data 18 to expansion processing and performing screen processing and pulse-width, conversion. In this embodiment, the compression ratio of the CMYKX image data 18 is high, and, therefore, the amount of data transferred from the host computer 10 to the printer 20 is small, and the transfer time is reduced, so that the printing throughput increases.

Luminance-related Values

In the above embodiment, the luminance values Y are determined from the RGB image data expanded into pixels and the resolution conversion is carried out based on whether a luminance-value differential between adjacent pixels is equal to or less than the threshold value. This is because image areas with small variations in luminance have slight color variations and, therefore, even when color conversion in these image areas is thinned somewhat, the human eye is unable to distinguish such variations sensitively. Therefore, a judgment of whether to perform resolution conversion may be made by using indicators that are inconspicuous to the human eye.

Therefore, only G (green) color data that has the largest effect on the luminance values Y among the RGB color data may be the subject of a comparison rather the luminance values Y. In this case, although there is the advantage that the calculation of luminance value Y can be omitted, there is the disadvantage that the measure for the resolution conversion is somewhat inferior. In addition, the brightness V of the HSV (Hue, Saturation, Value) color space is determined from the RGB color space, and then resolution conversion is performed depending on whether the brightness differential of adjacent pixels is equal to or less than the threshold value. The brightness V is the largest grayscale value (V=MAX (R, G, B)) among the RGB grayscale values, and, therefore, the computation processing to determine the brightness V can be simplified even in cases where the brightness V is taken as the reference. Further, when the image data expanded into pixels are HSV color spaces, the value of the brightness V thereof can be taken as the reference for the resolution conversion. Further, when the color spaces are grey spaces (luminance spaces), the pixel grayscale values themselves are luminance values.

Further Embodiment

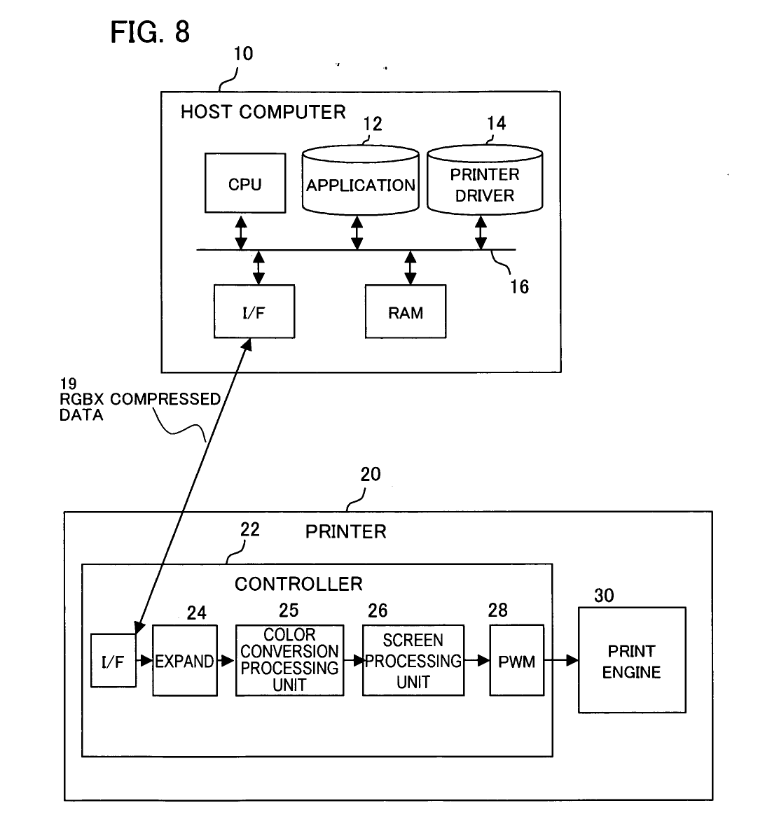

FIG. 8 shows the configuration of the host computer and printer according to another embodiment. In this example, a color conversion processing unit 25 is provided in the printer controller 22, compressed RGBX data 19 is transferred from the host computer 10 to the printer controller 22, and the controller 22 then performs expansion processing, color conversion processing, screen processing, and PWM processing.

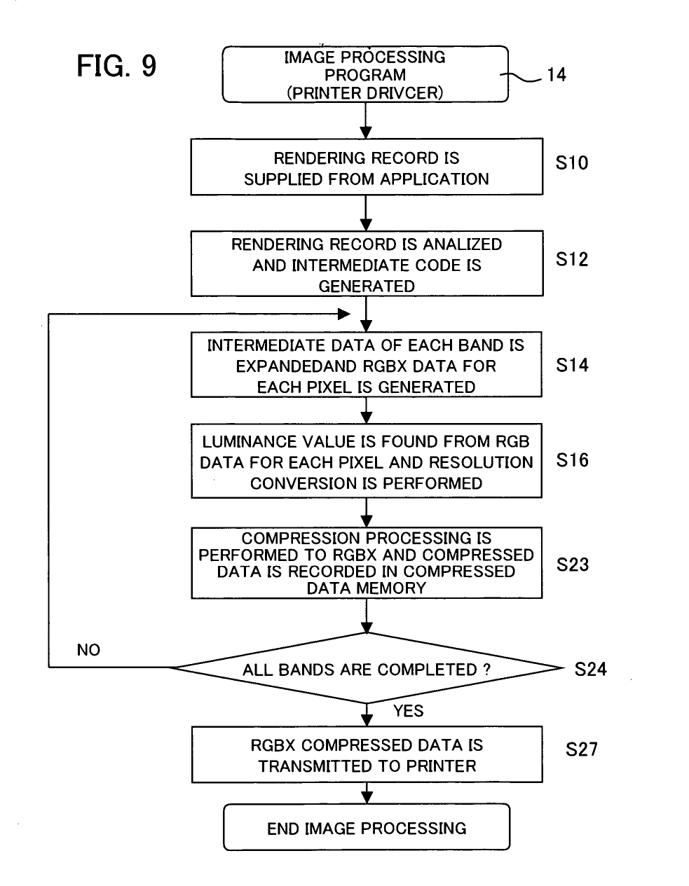

FIG. 9 is a flowchart showing the image processing procedure of the printer driver 14 of this embodiment. The same reference numerals have been assigned to the steps that are the same as those in the flowchart in FIG. 2. Steps S10 to S16, and S24 are the same steps as those of FIG. 2. In the case of this embodiment, after the resolution conversion processing S16 has been executed for the RGBX image data of each pixel, compression processing with an emphasis on repetition is performed on the RGBX data and the compressed data is then stored in the compressed data memory (S23). Further, when processing for all the bands is complete, the compressed RGBX data in the compressed data memory is then transferred to the printer (S27). That is, in this embodiment, the printer driver 14 does not color-convert the RGBX data into CMYKX data, but instead performs compression processing on RGBX data that is the result of thinning resolution-converted color data, then transferring the compressed data to the printer. So too here, because the repetition of the RGBX data is raised by means of resolution conversion, the compression ratio can be increased, the volume of transferred data can be reduced, and hence the transfer time can be shortened.

The present invention is applicable to a case where the resolution conversion processing, color conversion processing, and compression processing of the above embodiment are performed only on a rendering-record image, and a page-description language, which contains the compressed image data and rendering commands for characters, graphics, and so forth, is transferred from the host computer to the printer. In this case, because the volume of image data contained in the page-description language is reduced, the time for the transfer from the host computer to the printer can be shortened and the overall printing throughput can be improved.

1. An image processing program that causes a computer to execute an image processing procedure to generate image data for each pixel based on a rendering command, wherein
the image processing procedure comprises:
a procedure that expands image data for each pixel of a predetermined color space, based on the rendering command; and
a compression procedure that compresses the image data for each pixel by considering repetition of the image data, and wherein
the expansion procedure includes a resolution conversion procedure that replaces, with respect to an adjacent pixel group having a plurality of adjacent pixels, the image data for each pixel in the adjacent pixel group with the image data of any pixel in the adjacent pixel group, in cases where a differential of luminance-related values of the image data between the plurality of adjacent pixels is equal to or less than a predetermined threshold value.

2. The image processing program according to claim 1, wherein the luminance-related values are any of:
luminance values produced by adding together predetermined coefficients multiplied by respective RGB grayscale values in cases where the predetermined color space is an RGB space;
grayscale values in a case where the predetermined color space is a gray space (luminance space);
G (Green) grayscale values in a case where the predetermined color space is an RGB space;
the largest RGB grayscale values among the RGB grayscale values in a case where the predetermined color space is an RGB space;
luminance values produced by adding together predetermined coefficients multiplied by respective CMY grayscale values in cases where the predetermined color space is a CMY space; and
brightness (V value) in cases where the predetermined color space is an HSV (Hue, Saturation, Value) space.

3. The image processing program according to claim 1, further comprising:
a color conversion procedure that sequentially converts the image data for each pixel of the predetermined color-space that is generated by the expansion procedure into image data of different color-space, wherein
in the color conversion procedure, after a predetermined pixel image data is color-converted, pixel that has the same image data as the predetermined pixel image data is provided with the color-converted image data.

4. The image processing program according to claim 3, wherein the image data color-converted by the color conversion procedure is compressed in the compression procedure.

5. The image processing program according to claim 1, wherein the adjacent pixel group consists of adjacent pixels of 2 rows and 2 columns, and the color conversion processing is performed on the basis of whether the differential of the luminance-related values between adjacent pixels in row, column, and oblique directions of the adjacent pixel group is equal to or less than the threshold value.

6. The image processing program according to claim 5, wherein, in the resolution conversion processing, in cases where the resolution conversion is performed in all of the four adjacent pixel groups arranged in two rows and two columns, the resolution conversion processing is repeated for respective representative pixels in the adjacent pixel groups of two rows and two columns.

7. The image processing program according to claim 1, wherein
the rendering command includes a character rendering command, a graphic rendering command and an image rendering command; and
the resolution conversion processing is performed at the time of the expansion procedure for the image rendering command, and is not performed in the expansion procedure for the character and graphic rendering commands.

8. An image processing program that cause a computer to execute an image processing procedure to generate image data for each pixel based on a rendering command and transfer the image data to a printing device, wherein the image processing procedure comprises:
a procedure that expands image data for each pixel of a predetermined color space , based on the rendering command;
a color conversion procedure that converts the image data of the predetermined color space for each pixel generated by the expansion procedure into image data for the color space of color material of the printing device; and
a compression procedure that compresses the color converted image data for each pixel by considering repetition of the image data,
the expansion procedure includes a resolution conversion procedure, which, with respect to an adjacent pixel group having a plurality of adjacent pixels, replaces the image data for each pixel in the adjacent pixel group with common image data in cases where a differential of luminance-related values of the image data between the plurality of adjacent pixels is equal to or less than a predetermined threshold value; and
in the color conversion procedure, after a predetermined pixel image data is color-converted, pixel that has the same image data as the predetermined pixel image data is provided with the color-converted image data.

9. An image processing device that generates image data for each pixel based on a rendering command, comprising:
a data expansion unit that produces image data for each pixel of a predetermined color space, based on the rendering command; and
a compression unit that compresses the image data for each pixel by considering repetition of the image data,
wherein the data expansion unit includes a resolution conversion unit that replaces, with respect to an adjacent pixel group having a plurality of adjacent pixels, the image data for each pixel in the adjacent pixel group with the image data of any pixel in the adjacent pixel group, in cases where a differential of luminance-related values of the image data between the plurality of adjacent pixels is equal to or less than a predetermined threshold value.

10. An image processing device that generates image data for each pixel based on a rendering command and transfers the image data to a printing device, comprising:
a data expansion unit that produces image data for each pixel of a predetermined color space, based on the rendering command;
a color conversion unit that converts the image data of the predetermined color space for each pixel generated by the data expansion unit into image data for the color space of color material of the printing device; and
a compression unit that compresses the color-converted image data for each pixel by considering repetition of the image data,
wherein the data expansion unit includes a resolution conversion unit which replaces, with respect to an adjacent pixel group having a plurality of adjacent pixels, the image data for each pixel in the adjacent pixel group with common image data in cases where a differential of luminance-related values of the image data between the plurality of adjacent pixels is equal to or less than a predetermined threshold value; and,
after color-converting a predetermined pixel image data, the color conversion unit provides pixel that has the same image data as the predetermined pixel image data with the color-converted image data.

11. An image processing method for generating image data for each pixel based on a rendering command, comprising:
a data expansion procedure to produce image data for each pixel of a predetermined color space, based on the rendering command; and
a compression procedure of compressing the image data for each pixel by considering repetition of the image data,
wherein the data expansion procedure includes a resolution conversion procedure that replaces, with respect to an adjacent pixel group having a plurality of adjacent pixels, the image data for each pixel in the adjacent pixel group with the image data of any pixel in the adjacent pixel group in cases where a differential of luminance-related values of image data between the plurality of adjacent pixels is equal to or less than a predetermined threshold value.

12. An image processing method for generating image data for each pixel based on a rendering command and transfers the image data to a printing device, comprising:
a data expansion procedure to produce image data for each pixel of a predetermined color space, based on the rendering command;
a color conversion procedure of converting the image data of the predetermined color space for each pixel generated by the data expansion procedure into image data for the color space of color material of the printing device; and
a compression procedure of compressing the color-converted image data for each pixel by considering repetition of the image data,
wherein the data expansion procedure includes a resolution conversion procedure which replaces, with respect to an adjacent pixel group having a plurality of adjacent pixels, the image data for each pixel in the adjacent pixel group with common image data in cases where a differential of luminance-related values of the image data between the plurality of adjacent pixels is equal to or less than a predetermined threshold value; and,
in the color conversion step, after a predetermined pixel image data is color-converted, pixel that has the same image data as the predetermined pixel image data is provided with the color-converted image data.
